(19) United States
(12) Patent Application Publication
(10) Pub. No.: US 2024/0214283 A1
(43) Pub. Date: Jun. 27, 2024

(54) LATENCY MEASUREMENT SYSTEM AND METHOD

(71) Applicant: ATI TECHNOLOGIES ULC, Markham (CA)

(72) Inventors: Gennadiy Kolesnik, Richmond Hill (CA); Mikhail Mironov, Richmond Hill (CA)

(21) Appl. No.: 18/088,935

(22) Filed: Dec. 27, 2022

(51) Int. Cl. H04N 21/438; H04N 21/442

(52) U.S. Cl. CPC H04N 21/4384; H04N 21/44209

(57) ABSTRACT

A client latency module generates a trigger event in response to an input event. The trigger event is inserted into an event queue to be sent to a content provider system. A stream including a plurality of images, audio data, or both, is received from the content provider system. A trigger event response generated in response to the trigger event is identified from the stream. A stream latency is determined by comparing a time corresponding to the trigger event with a time corresponding to the trigger event response. As a result, a single timer is used to measure latency of a streaming solution.

### BACKGROUND

Streaming applications, such as remote desktop applications, cloud gaming services, or virtual desktop infrastructure (VDI) applications include a server of a content provider running an application that generates data being streamed and a client system that receives the data being streamed and sends the data to a display to be shown to a user. In some cases, the client system includes various user input devices, such as a keyboard, a mouse, or a game controller. In such cases, inputs from the user input devices are sent to the server and modify the stream. It is desirable for those modifications to occur as quickly as possible, relative to the inputs, to avoid a potentially negative user experience. Accordingly, it is desirable to measure latency between when inputs are detected and when the corresponding stream modification occurs to facilitate the user experience. However, measuring latency between a time at which an input is detected and a time at which a corresponding action appears to the user is difficult because multiple systems which do not share a single time reference (e.g., a single clock) are involved. One potential solution is to modify a user input device to provide a cue, such as a light, when an input is detected and then use a camera to record the user input device and a user display simultaneously. As a result, the camera can detect a time between a frame where the input is detected and a frame where a resulting stream modification appears on the user display. However, such a system requires a camera with a specific physical arrangement that captures both the user input device and the display. Further, such a system uses a relatively sophisticated image analysis to compensate for effects such as ambient lighting. Accordingly, such a system is undesirably cumbersome.

### BRIEF DESCRIPTION OF THE DRAWINGS

The present disclosure is better understood, and its numerous features and advantages made apparent to those skilled in the art, by referencing the accompanying drawings. The use of the same reference symbols in different drawings indicates similar or identical items.

FIG. 1 is a block diagram of a first embodiment of a latency measurement system in accordance with some embodiments.

FIG. 2 is a block diagram of a second embodiment of a latency measurement system in accordance with some embodiments.

FIG. 3 is a block diagram of a third embodiment of a latency measurement system in accordance with some embodiments.

FIG. 4 is a block diagram of a processing system that includes at least a portion of a latency measurement system in accordance with some embodiments.

FIG. 5 is a block diagram of a network system that includes at least a portion of a latency measurement system in accordance with some embodiments.

FIG. 6 is a block diagram of a network system that includes at least a portion of a latency measurement system in accordance with some embodiments.

FIG. 7 is a flow diagram of a first method of measuring latency in accordance with some embodiments.

FIG. 8 is a flow diagram of a second method of measuring latency in accordance with some embodiments.

### DETAILED DESCRIPTION

A latency measurement system includes a client latency module of a client system and, in some embodiments, a content provider latency module, a client streaming module, a content provider streaming module, a display, or any combination thereof. The client latency module generates a trigger event in response to an input event and sends the trigger event to the client streaming module to be sent to a content provider system. In some embodiments, in response to the trigger event, the content provider latency module generates a trigger event response that includes an indication that the trigger event response was generated in response to the trigger event. For example, in some cases, the trigger event response is an image that includes a predetermined pattern in a particular location. As another example, the trigger event response is a predetermined audio sequence. The content provider latency module inserts the trigger event response into a stream sent from the content provider streaming module to the client streaming module. The client streaming module sends images of the stream to the display, audio content of the stream to an audio device such as speakers or headphones, or both. In some embodiments, the client latency module captures the images being sent to the display and detects the trigger event response. In some embodiments, the client latency module captures the audio being sent to the audio device and detects the trigger event response. As a result, a latency between a time when the trigger event is generated and a time when the trigger event response is detected is determined. This latency represents a timing between detection of an input event and a resulting marker being output by the client streaming module. In some embodiments, a final latency is determined based on averaging results of a plurality of latency tests. Additionally, in some embodiments, latencies are measured between the client system and multiple content provider streaming modules.

Accordingly, based on the determined latency, in some cases, the client streaming module connects to a different content provider streaming module, stream settings (e.g., resolution settings) are changed, or both. Further, the latency measurement systems described herein are lower cost, as compared to other ways of measuring latency, such as using a camera to record an input and a displayed result. Additionally, the latency measurement systems described herein are agnostic of a streaming solution used by the content provider.

The techniques described herein are, in different embodiments, employed using any of a variety of processors (e.g., single core central processing units (CPUs) or multi-core CPUs) or parallel processors (e.g., vector processors, graphics processing units (GPUs), general-purpose GPUs (GPGPUs), non-scalar processors, highly-parallel processors, artificial intelligence (AI) processors, inference engines, machine learning processors, other multithreaded processing units, and the like). For ease of illustration, reference is made herein to example systems and methods in which processing modules are employed. However, it will be understood that the systems and techniques described herein apply equally to the use of other types of parallel processors unless otherwise noted.

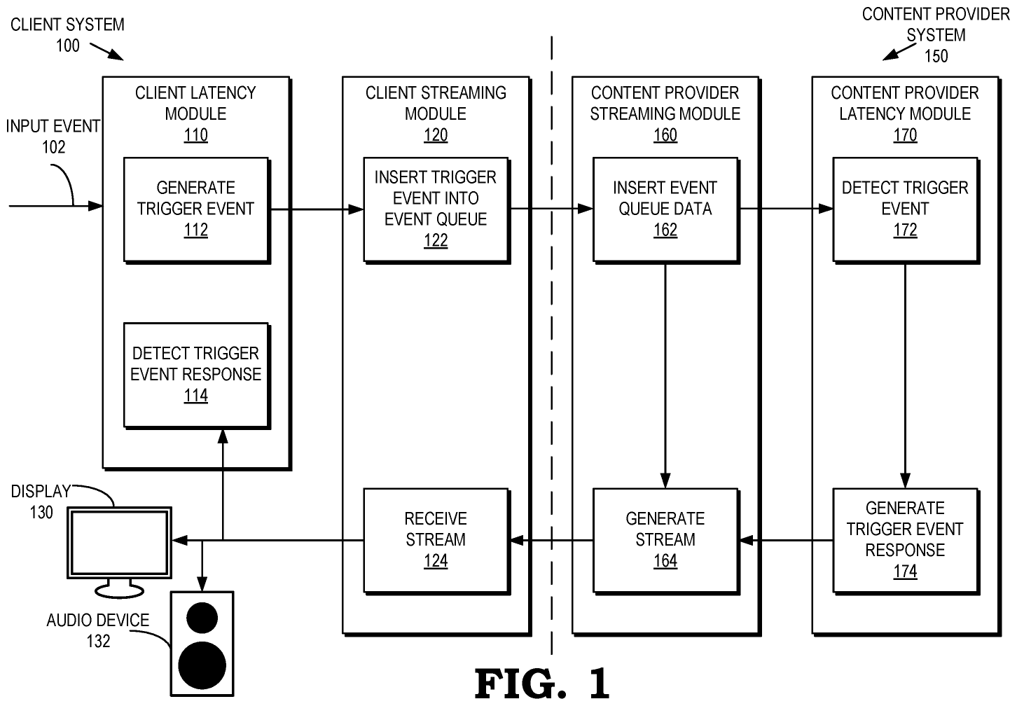

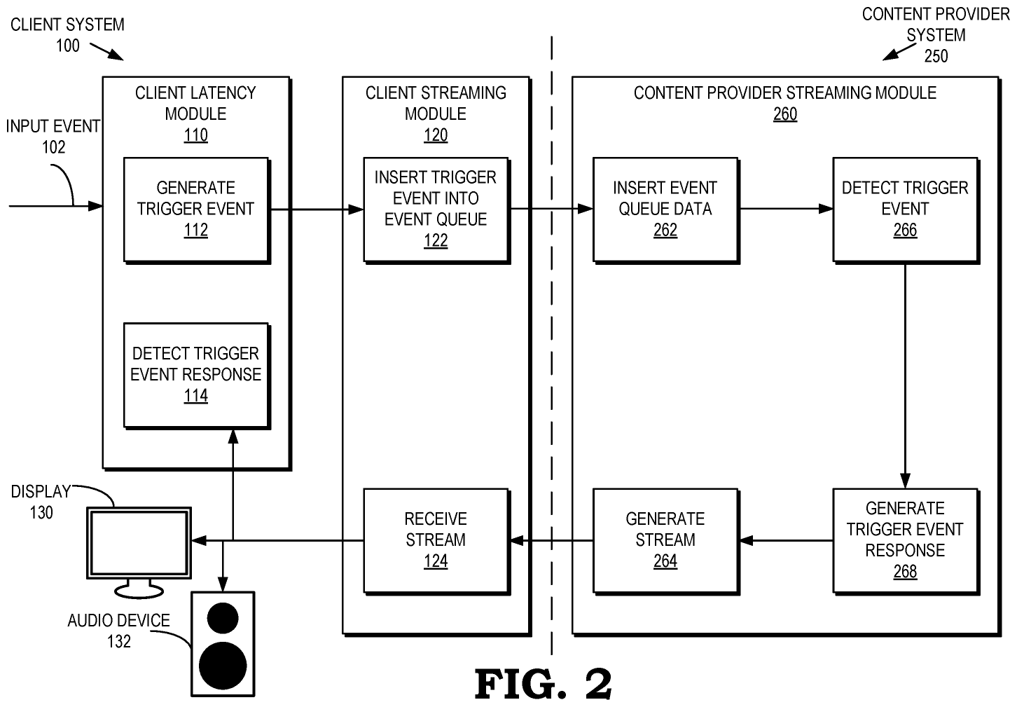

FIG. 1 illustrates a first block diagram of a latency measurement system in accordance with some embodiments. In various embodiments, the latency measurement system includes at least a portion of one or more of a client system 100 and a content provider system 150. Client system 100 includes a client latency module 110, a client streaming module 120, a display 130, and an audio device 132. Content provider system 150 includes content provider streaming module 160 and content provider latency module 170. For clarity and ease of explanation, FIG. 1 only includes the components listed above. However, in various embodiments, additional components, such as encoders/decoders, network transmission hardware, user input devices, memory devices, etc. are contemplated. Further, in some embodiments, fewer components are contemplated. For example, as described below with reference to FIG. 2, in some embodiments, content provider system 150 does not include content provider latency module 170. As another example, in some embodiments, client system 100 does not include display 130, audio device 132, or both. In some embodiments, the latency measurement system only includes client latency module 110. In other embodiments, the latency measurement system includes other portions of client system 100, some or all of content provider system 150, display 130, audio device 132, or any combination thereof. In some embodiments, display 130 and audio device 132 are integrated into a single device. In the illustrated embodiment, client latency module 110 and client streaming module 120 are executing on client system 100 (e.g., executing at a processor of client system 100). Further, in the illustrated embodiment, content provider streaming module 160 and content provider latency module 170 are executing on content provider system 150.

In the illustrated embodiment, content provider system 150 is providing some sort of streaming service to client system 100, such as a remote desktop application, a cloud gaming service, or a VDI application. For ease of illustration, reference will be made to the streaming service as being a cloud gaming service in which a video game is executed at content provider streaming module 160 of content provider system 150 in response to inputs from client streaming module 120 of client system 100. Video is sent from content provider streaming module 160 to client streaming module 120 to be displayed at display 130, showing a user's game progress in response to the inputs. In some cases, the latency measurement test described below is performed in conjunction with a test stream generated by content provider system 150 (e.g., a plurality of background images similar to, but not identical to an image used as a trigger event response). In other cases, the latency measurement test is performed as game data is sent from content provider system 150 to client system 100.

As discussed above, in the illustrated embodiments, latency is measured relative to a timing of an input event, such as input event 102. In some embodiments, input event 102 is received by client latency module 110 from an external source such as a user input device (e.g., a mouse, keyboard, or game controller), a program running on client system 100, a recording device, or from another system such as content provider system 150. In some embodiments, input event 102 is generated by client latency module 110 (e.g., as part of a latency test). In some embodiments, input event 102 is generated by client latency module 110 in response to an instruction from another system such as content provider system 150.

In response to input event 102, client latency module 110 generates a trigger event at box 112. The trigger event is a user input event to be placed in an event queue and corresponds at client latency module 110 to a time at client system 100 associated with input event 102. For example, in some cases, the trigger event corresponds to a time at which the trigger event is inserted into an event queue of client streaming module 120. In some embodiments, to facilitate a consistent latency measurement, the latency is based on a plurality of trigger events generated in response to different respective input events. In some embodiments, the trigger event includes an instruction to generate a trigger event response. In some embodiments, the trigger event is a signal or set of instructions that causes an image having particular characteristics (e.g., a predetermined object in a particular location or at least a portion of a predetermined object having a different color than a version of the predetermined object in one or more other images of the stream) to be generated. In some embodiments, the trigger event is a signal or set of instructions that causes an audio sequence to be generated. In some cases, the trigger event includes a timestamp. In other cases, the timestamp associated with the trigger event is saved at client system 100.

Subsequent to client latency module 110 generating the trigger event at box 112, the trigger event is sent to client streaming module 120, where the trigger event is inserted into an event queue at box 122. The event queue includes a plurality of events generated by client streaming module 120. For example, in some embodiments, the event queue is a portion of an operating system running on client system 100 and includes one or more game inputs. The trigger event is inserted using an event injection application programming interface (API), a driver such as a virtual input device driver, or another method of inserting or recording an event in the event queue. In some embodiments, rather than being inserted into the event queue, the trigger event is sent directly from client latency module 110 to content provider streaming module 160 or to content provider latency module 170.

Subsequent to client latency module 110 inserting the trigger event into the event queue at box 122, client streaming module 120 sends event queue data, which includes some or all of the event queue, to content provider system 150, where the event queue data is inserted into a memory accessible by content provider streaming module 160 at box 162. The event queue data is inserted at box 162 using an event injection API provided by an operating system of content provider system 150, a virtual input device driver, or some other method of inserting the event queue data into content provider streaming module 160. As a result, content provider streaming module 160 receives the game inputs and, in some cases, modifies data based on the game inputs (e.g., changing a plurality of images corresponding to a viewpoint of a game player or changing audio corresponding to actions of the game player). Subsequent to the event queue data being inserted, content provider streaming module 160 generates a plurality of images, an audio sequence, or both, to be sent to client system 100 as a stream at box 164. In some embodiments, content provider streaming module 160 renders the images, encodes the images, or both, prior to sending the stream to client system 100.

Content provider latency module 170 receives some or all of the data received by content provider streaming module 160. In some embodiments, content provider streaming module 160 sends the received data to content provider latency module 170. In other embodiments, content provider latency module 170 captures data received at content provider streaming module 160. At box 172, content provider latency module 170 analyzes the received data and detects the trigger event. In response to detecting the trigger event, at box 174, content provider latency module 170 generates a trigger event response. In various embodiments, the trigger event response is an image that has some characteristic that is to be recognized by client latency module 110. For example, in one case, the trigger event response includes a version of a predetermined object that is in a different location than a version of the predetermined object in one or more other images rendered by content provider streaming module 160. As another example, the trigger event response includes a particular color in a particular position (e.g., a red pixel in the top right corner) or includes a predetermined object that has a particular color (e.g., a blue star). In some embodiments, the trigger event response is a particular audio sequence. The trigger event response is inserted into the stream generated by content provider streaming module 160 at box 164.

Client streaming module 120 receives the stream from content provider system 150 at box 124. In some embodiments, client streaming module 120 decodes the stream, post-processes the stream, or both. Client streaming module 120 sends images of the stream to display 130 to be displayed. Client streaming module 120 sends audio data of the stream to audio device 132 (e.g., speakers or headphones) to be played. Additionally, client latency module 110 receives the stream (e.g., by receiving the stream from client streaming module 120, by capturing communications between client streaming module 120 and display 130 and/or audio device 132, or by capturing data from display 130, from audio device 132, or both).

Client latency module 110 parses the received stream data and detects the trigger event response generated in response to the trigger event at box 114. Client latency module 110 then determines a stream latency by comparing a time corresponding to the timestamp indicator (e.g., a time corresponding to insertion of the trigger event into the event queue) with a time corresponding to the trigger event response (e.g., a time corresponding to detection of the trigger event response at client latency module 110). In some embodiments, additional input events are received or generated and additional stream latencies are determined (e.g., 5 additional stream latencies or 50,000 additional stream latencies). Accordingly, in some embodiments, the stream latency is determined by comparing (e.g., averaging or otherwise weighting) a plurality of timings of trigger event responses to respective timings of a plurality of timings of trigger events.

In some embodiments, client streaming module 120 is aware of client latency module 110. In some cases, client streaming module 120 has an input to receive trigger events from client latency module 110. In some cases, client streaming module 120 forwards received streams to client latency module 110. In other embodiments, client streaming module 120 is unaware of client latency module 110. In some cases, client latency module 110 inserts the trigger event into the event queue at box 122 using an interface not designed for client latency module 110 (e.g., a general API or a virtual driver). Similarly, in some cases, client latency module 110 captures communications between client streaming module 120 and display 130 or captures images of the stream from display 130. Further, in some cases, client latency module 110 captures communications between client streaming module 120 and audio device 132 or captures audio of the stream from audio device 132.

In some embodiments, content provider streaming module 160 is aware of content provider latency module 170. In some cases, content provider streaming module 160 has an input to receive trigger event responses from content provider latency module 170 and sends received event queue data to content provider latency module 170. In other embodiments, content provider streaming module 160 is unaware of content provider latency module 170. In some cases, content provider latency module 170 inserts the trigger event response into the stream at box 164 using an interface not designed for content provider latency module 170 (e.g., a general API or a virtual driver). Similarly, in some cases, content provider latency module 170 captures communications received at content provider system 150 from client streaming module 120.

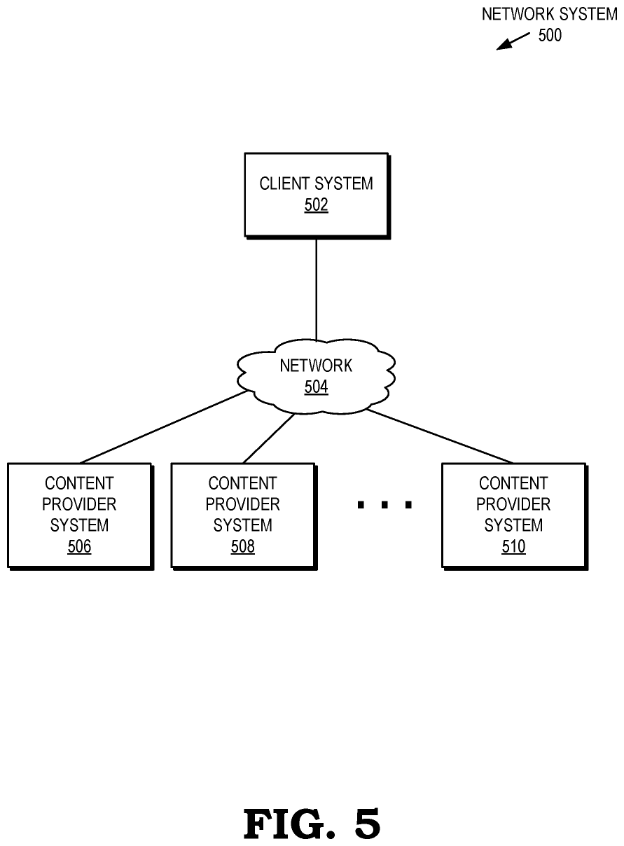

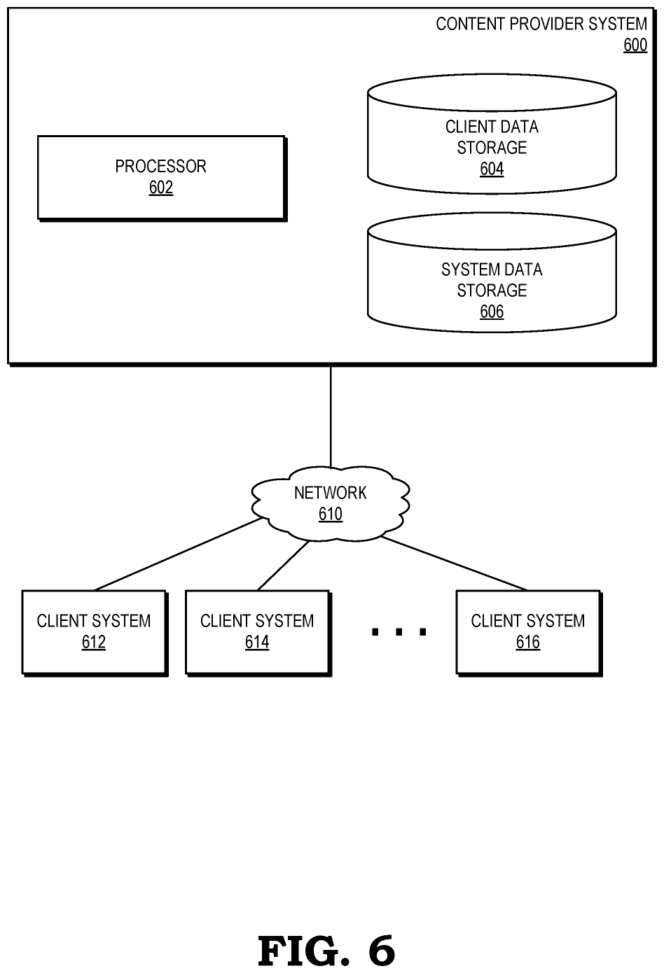

Accordingly, a latency between client system 100 and content provider system 150 is calculated. As a result, as further discussed below with reference to FIGS. 5 and 6, various actions can be taken based on the latency (e.g., based on comparing the latency to one or more thresholds), such as client system 100 initiating a stream from a different content provider system or changing various stream settings such as a stream resolution. For example, in response to the latency being less than a resolution threshold, the stream resolution is decreased. As another example, in response to the latency being greater than a resolution threshold, the stream resolution is increased.

FIG. 2 illustrates a second block diagram of a latency measurement system in accordance with some embodiments. In various embodiments, the latency measurement system includes at least a portion of one or more of a client system 100 and a content provider system 250. In the illustrated embodiment, client system 100 functions in a same manner as client system 100 of FIG. 1. Content provider system 250 includes content provider streaming module 260. For clarity and ease of explanation, FIG. 2 only includes the components listed above. However, in various embodiments, additional components, such as encoders/decoders, network transmission hardware, user input devices, memory devices, etc. are contemplated. Further, in some embodiments, fewer components are contemplated. For example, in some embodiments, client system 100 does not include display 130, audio device 132, or both. In some embodiments, the latency measurement system only includes client latency module 110. In other embodiments, the latency measurement system includes other portions of client system 100, some or all of content provider system 250, display 130, audio device 132, or any combination thereof. In some embodiments, display 130 and audio device 132 are integrated into a single device. In the illustrated embodiment, client latency module 110 and client streaming module 120 are executing on client system 100. Further, in the illustrated embodiment, content provider streaming module 260 is executing on content provider system 250.

As stated above, client system 100 functions in a same manner as client system 100 of FIG. 1. Further, the explanation below will again be provided using video game inputs as an example, however the embodiment described herein is not so limited. Contrary to content provider system 150 of FIG. 1, content provider system 250 does not include a content provider latency module. Instead, in the illustrated embodiment, content provider streaming module 260 generates a trigger event response in response to a trigger event. In some embodiments, content provider streaming module 260 is configured to generate a particular marker in response to a particular set of inputs (e.g., generating a test image or a test audio sequence in response to a specific test input), which client system 100 uses to measure latency. In some embodiments, content provider streaming module 260 includes a module that operates in a manner similar to content provider latency module 170.

Subsequent to client latency module 110 inserting the trigger event into the event queue at box 122, client streaming module 120 sends event queue data, including some or all of the event queue, to content provider system 250, where the event queue data is inserted into a memory accessible by content provider streaming module 260 at box 262. The event queue data is inserted at box 262 using an event injection API provided by an operating system of content provider system 250, a virtual input device driver, or some other method of inserting the event queue data into content provider streaming module 260. As a result, content provider streaming module 260 receives the game inputs and, in some cases, modifies data based on the game inputs (e.g., changing a plurality of images corresponding to a viewpoint of a game player or changing audio corresponding to actions of the game player). At box 266, content provider streaming module 260 analyzes the received data and detects the trigger event. In response to detecting the trigger event, at box 268, content provider streaming module 260 generates a trigger event response. In various embodiments, the trigger event response is an image that has some characteristic that is to be recognized by client latency module 110. For example, in one case, the trigger event response is an image that includes a predetermined object that is in a different location from one or more other images rendered by content provider streaming module 160. As another example, the trigger event response is an image that includes a particular color in a particular position (e.g., a red pixel in the top right corner) or includes a predetermined object that has a particular color (e.g., a blue star). In other embodiments, the trigger event response is an audio sequence that has a characteristic that is to be recognized by client latency module 110. For example, in one case, the trigger event response is a particular audio frequency played for a particular amount of time. As another example, the trigger event response is a sequence of different audio frequencies. Subsequent to the event queue data being inserted at box 262, content provider streaming module 260 generates a plurality of images, an audio sequence, or both, to be sent to client system 100 as a stream at box 264. The trigger event response is inserted into the stream at box 264. In some embodiments, content provider streaming module 260 renders the images, encodes the images, or both, prior to sending the stream to client system 100. The stream is then used in a manner as described above with reference to FIG. 1 to measure a latency.

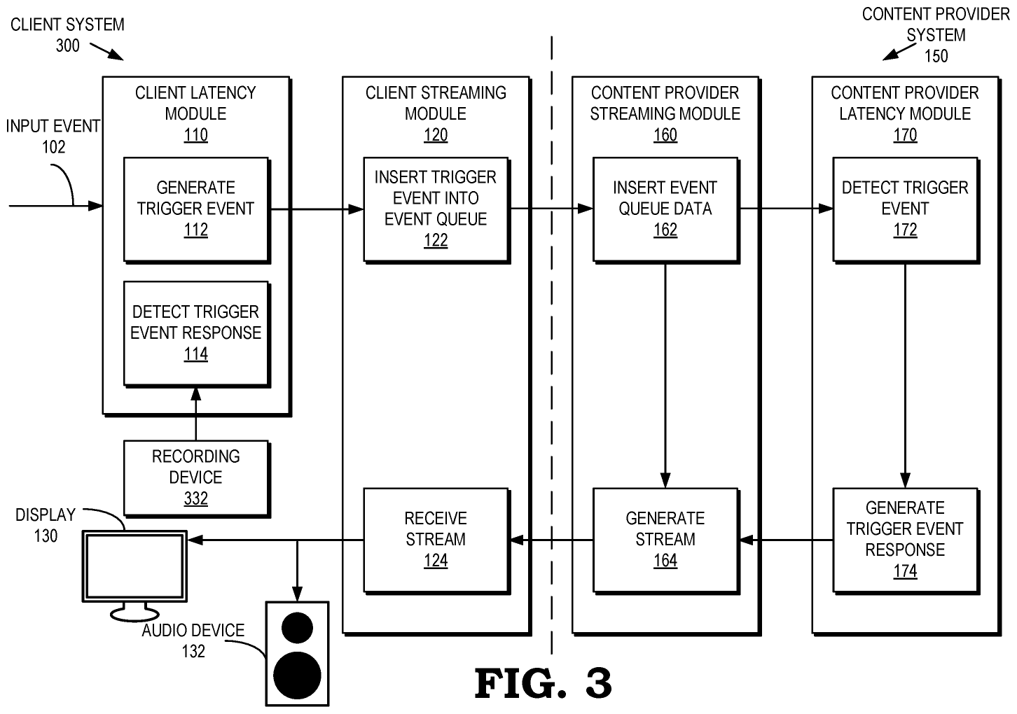

FIG. 3 illustrates a third block diagram of a latency measurement system in accordance with some embodiments. In various embodiments, the latency measurement system includes at least a portion of one or more of a client system 300 and a content provider system 150. Client system 300 includes client latency module 110, client streaming module 120, display 130, audio device 132, and recording device 332. In the illustrated embodiment, content provider system 150, client latency module 110, and client streaming module 120 function in a same manner as content provider system 150, client latency module 110, and client streaming module 120 of FIG. 1. For clarity and ease of explanation, FIG. 3 only includes the components listed above. However, in various embodiments, additional components, such as encoders/decoders, network transmission hardware, user input devices, memory devices, etc. are contemplated. Further, in some embodiments, fewer components are contemplated. For example, as described above with reference to FIG. 2, in some embodiments, content provider system 150 does not include content provider latency module 170. As another example, in some embodiments, client system 100 does not include display 130 or audio device 132. In some embodiments, the latency measurement system only includes client latency module 110. In other embodiments, the latency measurement system includes other portions of client system 300, some or all of content provider system 150, display 130, audio device 132, recording device 332, or any combination thereof. In some embodiments, display 130, audio device 132, recording device 332, or any combination thereof are integrated into a single device. In the illustrated embodiment, client latency module 110 and client streaming module 120 are executing on client system 100. Further, in the illustrated embodiment, content provider streaming module 160 and content provider latency module 170 are executing on content provider system 150.

As stated above, content provider system 150, client latency module 110, and client streaming module 120 function in a same manner as content provider system 150, client latency module 110, and client streaming module 120 of FIG. 1. Further, the explanation below will again be provided using video game inputs as an example, however the embodiment described herein is not so limited. Contrary to client system 100 of FIG. 1, client system 300 includes recording device 332, which detects the trigger event response and sends the trigger event response or an indication of the trigger event response to client latency module 110.

In some embodiments, recording device 332 is a screen sensor which is attached to display 130. In such embodiments, display 130 receives images of the stream from client streaming module 120. Recording device 332 identifies the trigger event response by detecting when one or more pixels displayed by display 130 correspond to the trigger event response. In response to detecting a trigger event response, recording device 332 sends an indication (e.g., a signal or the trigger event response) to client latency module 110 where the trigger event response is detected at box 114 and the latency measurement is then calculated. Accordingly, in some embodiments, a display latency associated with display 130 is included in the latency measurement. In various embodiments, recording device 332 is cheaper and easier to set up as compared to a camera that records an input and the display. In some embodiments, recording device 332 is a single photo diode.

In some embodiments, recording device 332 is an audio detector such as a microphone placed proximate to or attached to audio device 132. In such embodiments, audio device 132 receives audio data of the stream from client streaming module 120. Recording device 332 identifies the trigger event response by detecting a predetermined audio sequence corresponding to the trigger event response. In response to detecting a trigger event response, recording device 332 sends an indication (e.g., a signal or the trigger event response) to client latency module 110 where the trigger event response is detected at box 114 and the latency measurement is then calculated. Accordingly, in some embodiments, a latency associated with audio device 132 is included in the latency measurement.

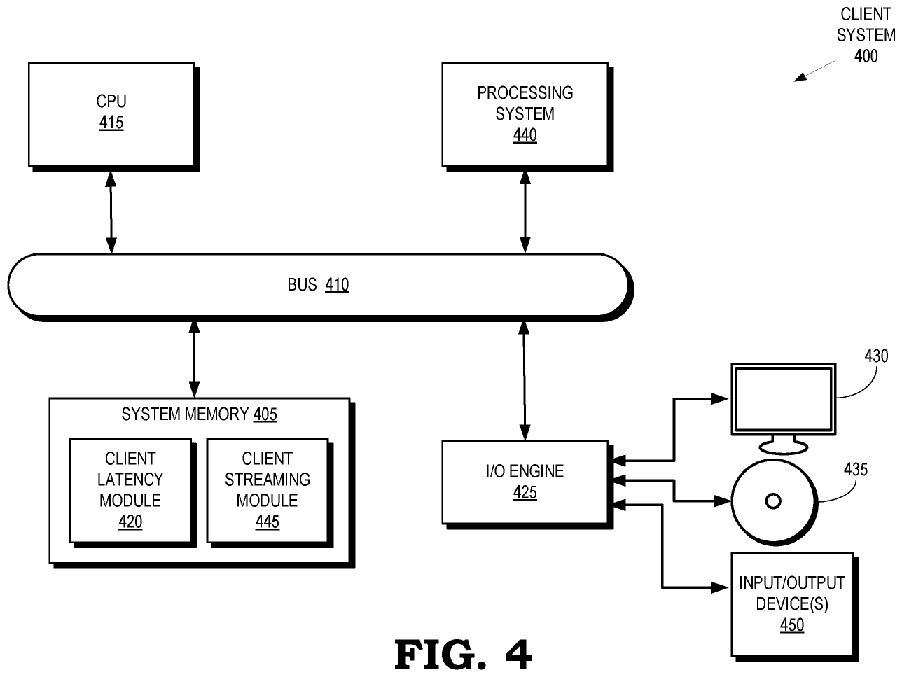

FIG. 4 is a block diagram depicting a client system 400 that includes at least a portion of a latency measurement system according to some embodiments. Client system 400 includes or has access to a system memory 405 or other storage component that, in some embodiments, is implemented using a non-transitory computer readable medium such as a dynamic random-access memory (DRAM). In various embodiments, system memory 405 additionally or alternatively includes or is implemented using other types of memory including static random-access memory (SRAM), nonvolatile RAM, and the like. In the illustrated embodiment, system memory 405 includes client latency module 420 and client streaming module 445. However, in other embodiments, system memory 405 only includes one of client latency module 420 and client streaming module 445. Client system 400 also includes a bus 410 to support communication between entities implemented in client system 400, such as system memory 405. Some embodiments of client system 400 include other buses, bridges, switches, routers, encoders/decoders, network interface devices, and the like, which are not shown in FIG. 4 in the interest of clarity.

Client system 400 includes processing system 440. In some embodiments, processing system 440 is a GPU that renders images for presentation on a display 430. For example, in some cases, the processing system 440 renders objects to produce values of pixels that are provided to display 430, which uses the pixel values to display an image that represents the rendered objects. In some embodiments, processing system 440 is a general purpose processor (e.g., a CPU) or a GPU used for general purpose computing. In the illustrated embodiment, display 430 functions in a same manner as display 130 of FIG. 1. In the illustrated embodiment, an audio device which is one of input/output devices 450 functions in a same manner as audio device 132 of FIG. 1. In the illustrated embodiment, processing system 440 communicates with system memory 405 over bus 410. However, some embodiments of processing system 440 communicate with system memory 405 over a direct connection or via other buses, bridges, switches, routers, and the like. In some embodiments, processing system 440 executes instructions stored in system memory 405, such as instructions relating to client latency module 420 or to client streaming module 445, and processing system 440 stores information in system memory 405 such as the results of the executed instructions.

Client system 400 also includes a central processing unit (CPU) 415 configured to execute instructions concurrently or in parallel. The CPU 415 is connected to the bus 410 and, in some cases, communicates with processing system 440 and system memory 405 via bus 410. In some embodiments, CPU 415 executes instructions such as instructions relating to client latency module 420 or to client streaming module 445 stored in system memory 405 and CPU 415 stores information in system memory 405 such as the results of the executed instructions.

An input/output (I/O) engine 425 handles input or output operations associated with display 430, as well as other elements of client system 400 such as input/output device(s) 450, which include keyboards, mice, game controllers, audio devices such as speakers or headphones, printers, external disks, and the like. In some embodiments, input/output device(s) 450 produce signals that are identified as input events such as input event 102 of FIG. 1. I/O engine 425 is coupled to bus 410 so that I/O engine 425 is able to communicate with system memory 405, processing system 440, and CPU 415. In the illustrated embodiment, I/O engine 425 is configured to read information stored on an external storage component 435, which is implemented using a non-transitory computer readable medium such as a compact disk (CD), a digital video disc (DVD), and the like. In some cases, I/O engine 425 writes information to external storage component 435, such as the results of processing by processing system 440 or CPU 415.

FIG. 5 is a block diagram depicting a network system 500 that includes at least a portion of a latency measurement system according to some embodiments. In the illustrated embodiment, network system 500 includes client system 502, network 504, content provider system 506, content provider system 508, and content provider system 510. In some embodiments, client system 502 corresponds to client system 100 of FIGS. 1 and 2 or client system 300 of FIG. 3. In some embodiments, content provider system 506 corresponds to content provider system 150 of FIGS. 1 and 3 or content provider system 250 of FIG. 2. In some embodiments, content provider system 506 corresponds to content provider system 150 and content provider system 508 corresponds to content provider system 250.

In the illustrated embodiment, each of content provider system 506, content provider system 508, and content provider system 510 provide similar streaming services to client systems. However, it is desirable to determine the connection with the smallest amount of latency between client system 502 and a content provider system. Accordingly, the latency measurement described herein is implemented with between client system 502 and each of content provider system 506, content provider system 508, and content provider system 510. Subsequently, a stream (e.g., a connection where game content is provided by a particular content provider system) is maintained with a content provider system having a lowest latency (e.g., content provider system 510) and network connections with the other content provider systems (e.g., content provider system 506 and content provider system 508) are dropped. In another embodiment, network connections with content provider systems not having a lowest latency are maintained but not used to stream content. Latency measurement is periodically performed and if, after a subsequent latency measurement test, another content provider system is found to have a lower latency, a stream is initiated from that provider to client system 502 instead.

FIG. 6 is a block diagram depicting a network system that includes at least a portion of a latency measurement system according to some embodiments. The network system includes a content provider system 600, a network 610, a client system 612, a client system 614, and a client system 616. The content provider system 600 includes at least a processor 602, a client data storage 604, and a system data storage 606. In some embodiments, the content provider 600 corresponds to content provider system 150 of FIG. 1 or 3 or to content provider system 250 of FIG. 2. Additionally, in some embodiments, at least one of client system 612, client system 614, or client system 616 corresponds to one of client system 100 of FIG. 1 or 2 or client system 300 of FIG. 3. For example, in some embodiments, content provider 600 corresponds to content provider system 150 of FIG. 1, client system 612 corresponds to client system 100 of FIG. 1, and client system 614 corresponds to client system 300 of FIG. 3. Some embodiments of content provider system 600 include other buses, bridges, switches, routers, encoders/decoders, memory devices, network interface devices, and the like, which are not shown in FIG. 6 in the interest of clarity. Although some elements are depicted individually (e.g., processor 602 or system data storage 606), in some embodiments, these elements are collections of multiple devices which are not necessarily physically adjacent.

Content provider system 600 provides streaming services to client system 612, client system 614, and client system 616. In the illustrated embodiment, content provider system 600 stores data (e.g., game state data) for each client in client data storage 604 and system data such as data used to by a content provider streaming module or a content provider latency module in system data storage 606. Processor 602 executes instructions related to providing streaming services to client systems 612-616. In some embodiments, processor 602 additionally executes instructions of a content provider streaming module, a content provider latency module, or both.

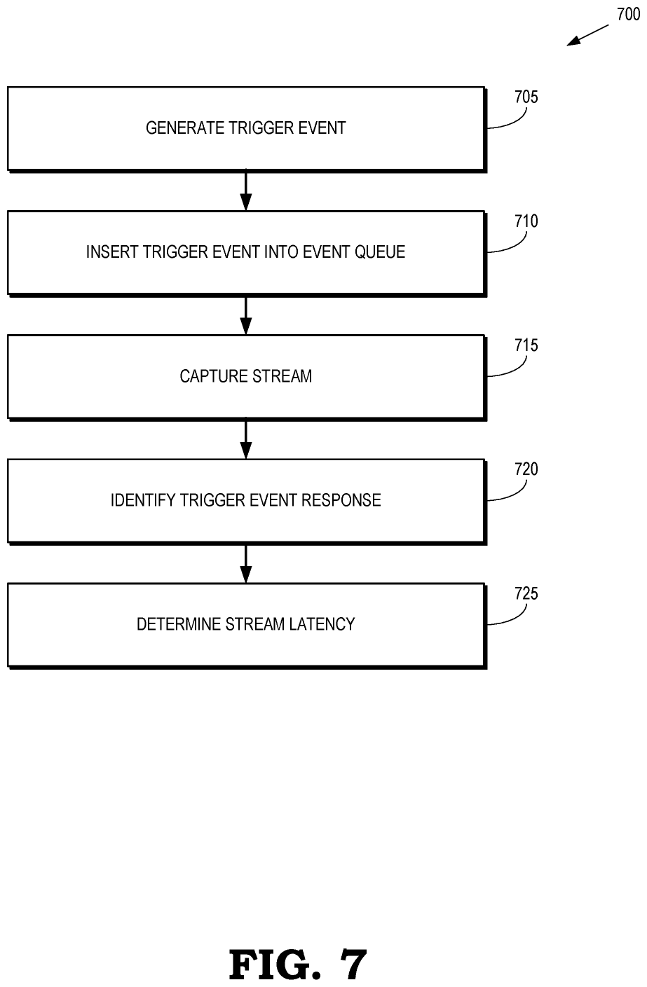

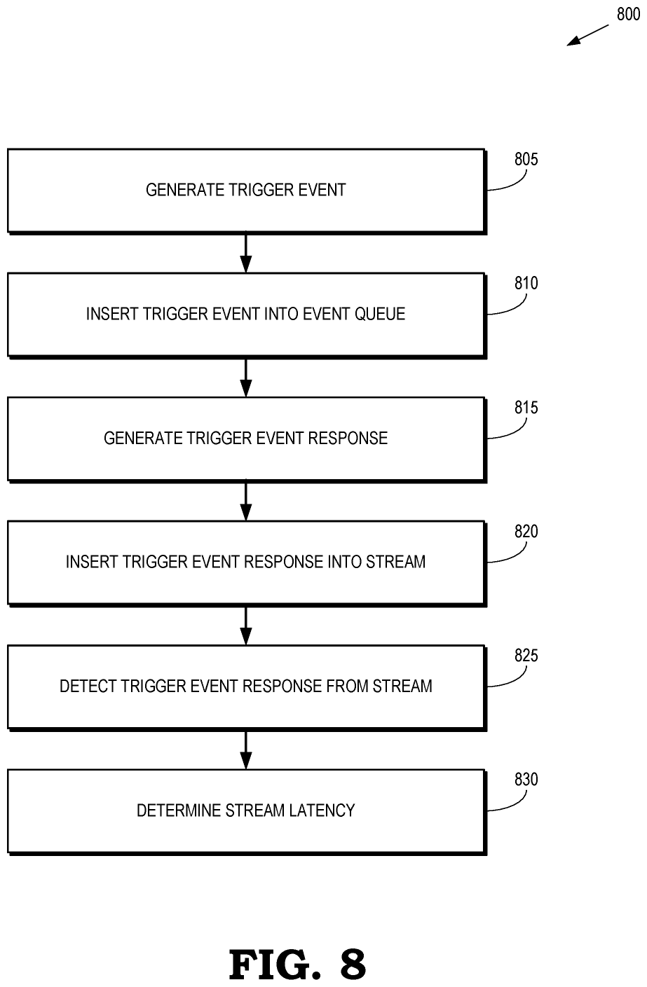

FIGS. 7 and 8 illustrate example methods of measuring latency in accordance with some embodiments. As described above with respect to FIGS. 1-3, several different systems are contemplated. FIG. 7 describes a method of measuring latency where a latency system includes at least a client latency module. FIG. 8 describes a method of measuring latency where a latency system includes at least a client latency module and a content provider latency module.

FIG. 7 is a flow diagram illustrating a first method of measuring latency in accordance with some embodiments. In some embodiments, method 700 is initiated by one or more processors in response to one or more instructions stored by a computer readable storage medium. In some embodiments, various portions of method 700 occur in a different order than is illustrated. For example, in some cases, the trigger event response is identified in block 720 before all of the stream has been captured in block 715.

At block 705, a trigger event is generated. For example, client latency module 110 receives an indication of an input event 102 and generates a user input event, a trigger event, at box 112. At block 710, the trigger event is inserted into an event queue. For example, client latency module 110 sends the trigger event into an event queue of client streaming module 120 at box 122.

At block 715, images of a stream are captured. For example, client latency module 110 captures images of a stream sent from client streaming module 120 to display 130 (e.g., by receiving the stream from client streaming module 120, by capturing communications between client streaming module 120 and display 130, or by capturing data from display 130). At block 720, a trigger event response is identified. For example, client latency module 110 parses the received stream and identifies a trigger event response generated in response to the trigger event.

At block 725, a stream latency is identified. For example, client latency module 110 compares a timing of the trigger event response with a timing of the trigger event to determine a stream latency. In some embodiments, this process is iterated to determine the stream latency. Accordingly, a method of measuring latency is depicted.

FIG. 8 is a flow diagram illustrating a second method of measuring latency in accordance with some embodiments. In some embodiments, method 800 is initiated by one or more processors in response to one or more instructions stored by a computer readable storage medium.

At block 805, a trigger event is generated. For example, client latency module 110 receives an indication of an input event 102 and generates a user input event, a trigger event, at box 112. At block 810, the trigger event is inserted into an event queue. For example, client latency module 110 sends the trigger event into an event queue of client streaming module 120 at box 122.

At block 815, a trigger event response is generated. For example, content provider latency module 170 detects the trigger event at box 172 and generates a trigger event response at box 174. At block 820, the trigger event response is inserted into a stream. For example, content provider latency module 170 inserts the trigger event response into the stream of content provider streaming module 160 at box 164.

At block 825, a trigger event response from the stream is identified. For example, client latency module 110 parses the received stream from client streaming module 120 or display 130 and identifies a trigger event response generated in response to the trigger event. At block 830, a stream latency is identified. For example, client latency module 110 compares a timing of the trigger event response with a timing of the trigger event to determine a stream latency. In some embodiments, this process is iterated to determine the stream latency. Accordingly, a method of measuring latency is depicted.

In some embodiments, a computer readable storage medium includes any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. In some embodiments, the computer readable storage medium is embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above are implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. In some embodiments, the executable instructions stored on the non-transitory computer readable storage medium are in source code, assembly language code, object code, or other instruction format that is interpreted or otherwise executable by one or more processors.

Note that not all of the activities or elements described above in the general description are required, that a portion of a specific activity or device are not required, and that, in some cases, one or more further activities are performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that cause any benefit, advantage, or solution to occur or become more pronounced are not to be construed as a critical, required, or essential feature of any or all the claims. Moreover, the particular embodiments disclosed above are illustrative only, as the disclosed subject matter could be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above could be altered or modified and all such variations are considered within the scope of the disclosed subject matter. Accordingly, the protection sought herein is as set forth in the claims below.

Within this disclosure, in some cases, different entities (which are variously referred to as “components,” “units,” “devices,” etc.) are described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

1. A method comprising:
generating, by a client latency module executing on a client system, a trigger event in response to an input event;
inserting the trigger event into an event queue to be sent to a content provider system;
capturing at least a portion of a stream received by a client streaming module executing on the client system from the content provider system comprising receiving a signal from a recording device that monitors output of the stream;
identifying a trigger event response from the output of the stream, wherein the trigger event response is generated in response to the trigger event; and
determining, based on a timing of the trigger event response and a timing of the trigger event, a stream latency.

2. The method of claim 1, wherein the event queue comprises events generated by the client streaming module.

3. The method of claim 1, further comprising:
initiating a second stream from a second content provider system to the client system based on the stream latency and based on a second stream latency corresponding to the second stream.

4. The method of claim 1, further comprising:
identifying, by a content provider latency module of the content provider system, the trigger event from event queue data of the event queue;
generating the trigger event response in response to the trigger event; and
inserting the trigger event response into the stream.

5. The method of claim 1, wherein the trigger event response is an image that comprises a predetermined object corresponding to the input event, and wherein at least one other image of the stream includes a version of the predetermined object having a different color than the predetermined object of the trigger event response.

6. The method of claim 1, wherein the trigger event response is an image that comprises a predetermined object corresponding to the input event, and wherein at least one other image of the stream includes a version of the predetermined object at a different location within the at least one other image as compared to the predetermined object of the trigger event response.

7. The method of claim 1, wherein capturing at least a portion of the stream comprises receiving images sent to a display, receiving audio data sent to an audio device, or both.

8. The method of claim 1, wherein the recording device comprises a screen sensor attached to a display.

9. The method of claim 1, wherein the recording device comprises a microphone placed proximate to an audio device.

10. The method of claim 1, wherein the input event is in response to a signal received from a user input device.

11. The method of claim 1, wherein the input event is initiated by the client latency module.

12. A method, comprising:
generating, by a client latency module executing on a client system, a trigger event in response to an input event;
inserting the trigger event into an event queue of a client streaming module executing on the client system;
generating, by a content provider latency module executing on a content provider system, a trigger event response in response to detecting the trigger event;
inserting the trigger event into a stream of the content provider system;
detecting, by the client latency module, the trigger event response from the stream comprising receiving an indication of the trigger event from a recording device that monitors output of the stream; and
determining, based on a timing of the trigger event response and a timing of the trigger event, a stream latency.

13. (canceled)

14. The method of claim 12, further comprising:
receiving, by the client system, the stream; and
sending, by the client system, a plurality of images of the stream to a display, sending audio data of the stream to an audio device, or both.

15. The method of claim 14, wherein detecting the trigger event response comprises capturing the audio data by the recording device as it is output by the audio device.

16. The method of claim 14, wherein detecting the trigger event response comprises receiving the plurality of images from the recording device, wherein the recording device is attached to the display.

17. A system comprising:
at least one processor; and
a non-transitory computer readable medium embodying a set of executable instructions, the set of executable instructions to manipulate the at least one processor to:
generate, by a client latency module executing on the at least one processor a trigger event in response to an input event;
insert the trigger event into an event queue of a client streaming module executing on the at least one processor;
capture at least a portion of a stream received by the client streaming module from a content provider system comprising receiving a signal from a recording device that monitors output of the stream;
identify a trigger event response from the output of the stream, wherein the trigger event response is generated in response to the trigger event; and
determine, based on a timing of the trigger event response and a timing of the trigger event, a stream latency.

18. The system of claim 17, wherein determining the stream latency comprises comparing a plurality of timings of trigger event responses to respective timings of a plurality of timings of trigger events.

19. The system of claim 17, wherein the set of executable instructions is to manipulate the at least one processor to:
in response to the stream latency being greater than a resolution threshold, increase a resolution setting associated with the stream.

20. The system of claim 17, wherein the set of executable instructions is to manipulate the at least one processor to:
in response to the stream latency being less than a resolution threshold, decrease a resolution setting associated with the stream.

21. The method of claim 8, wherein the screen sensor is a single photo diode attached to the display.
